(19) United States
(12) Patent Application Publication
(10) Pub. No.: US 2007/0147024 A1
(43) Pub. Date: Jun. 28, 2007

(54) Soft handle with a lighting apparatus

(76) Inventor: Michael Chien-Lung Wu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/318,860

(22) Filed: Dec. 28, 2005

(51) Int. Cl. A45B 3/02; F21V 5/00; F21V 23/04

(52) U.S. Cl. 362/102; 362/235; 362/318; 362/394

(57) ABSTRACT

The invention relates to a soft handle with a lighting apparatus, which includes a central rod connecting with a soft shell and liquid therein. A lighting apparatus is provided in the central rod to emit light passing through the transparent central rod and soft shell. Thus, the handle becomes a lighting source to increase the utilization for people when using the handle.

### BACKGROUND OF THE INVENTION

For comfortable use, a handle being provided with a soft shell and inner liquid is applied on many products. Then the known handle has soft contact surface for people holding comfortably even for a long period. But the known handle still has only a single function and can be improved whatever.

The present invention is to provide a soft handle with a lighting apparatus, which provides other functions accompanying with the known soft contact feeling. Now, accompanying with the following drawings, the character of the present invention will be described here and after.

### BRIEF DESCRIPTION OF THE DRAWINGS

FIG. 1 is an exploded perspective view showing a soft handle with a lighting apparatus according to the present invention.

FIG. 2 is an assembled perspective view of FIG. 1.

FIG. 3 is a partly cross-sectional plan view of FIG. 2.

FIG. 4 is a plan view showing an application of the soft handle according to the present invention.

### DETAILED DESCRIPTION OF THE PREFERRED EMBODIMENT

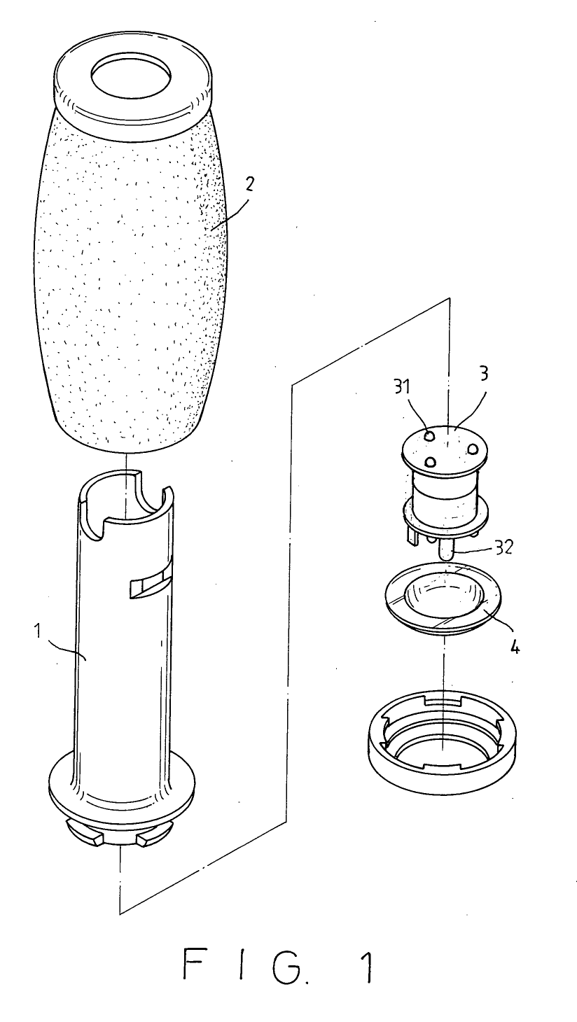

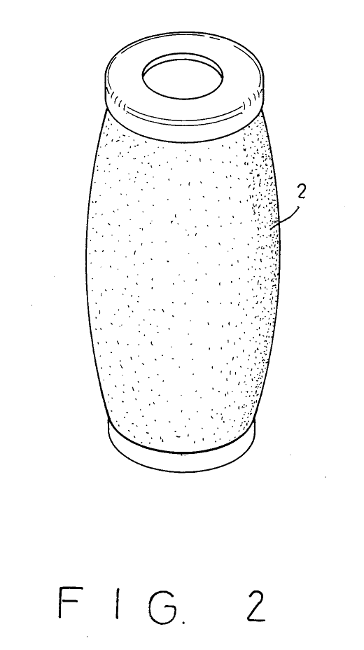

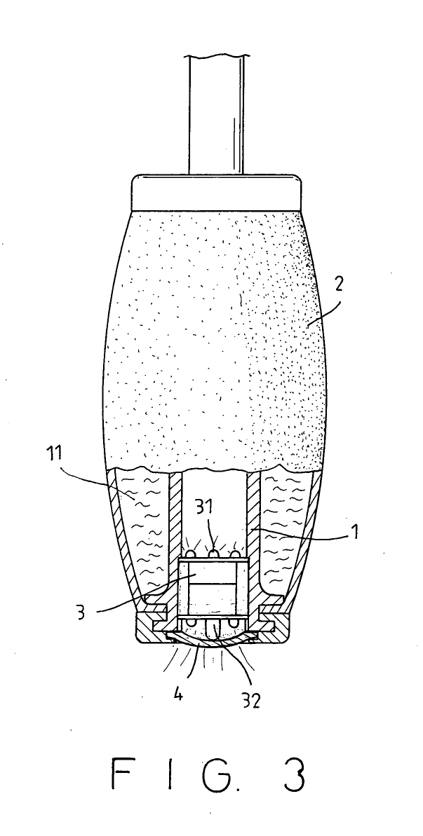

Referring to FIG. 1 to 4, the present invention includes a central rod (1) and a soft shell (2) with inner liquid (11). The character of the present invention is to provide a lighting apparatus (3) in lower portion of the central rod (1). The lighting apparatus (3) includes several LED bulbs (31) and a bottom switch (32). A soft cover (4) is connected at bottom of the central rod (1) outside the switch (32). Moreover, the central rod (1) and the soft shell (2) are made of transparent material.

In use, people can press the soft cover (4) as well as the switch (32) once to turn on the LED bulbs (31), which can emit light outside passing through the central rod (1) and the soft shell (2). Hence, the handle becomes a lighting source that can be a decorative object or a warning signal for users. Furthermore, the lighting apparatus (3) is capable of providing various circuits to display different lighting frequencies or rules for increasing the decorative purpose. A following press on the soft cover (4) and the switch (32) will turn off the bulbs (31).

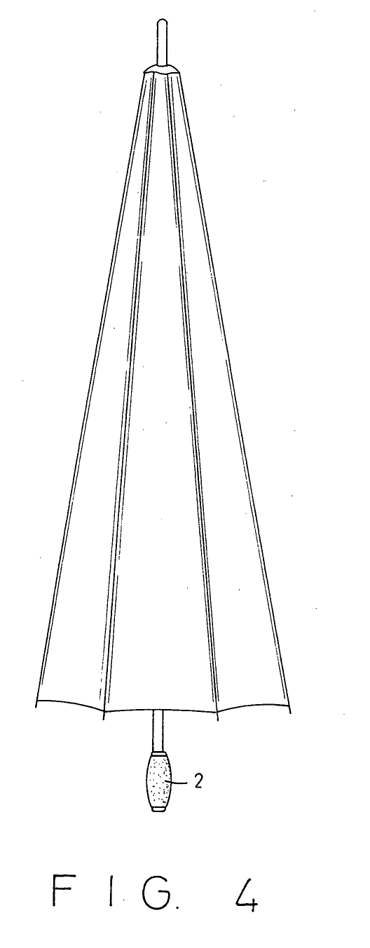

Accordingly, the present invention provides a soft handle with a lighting apparatus that increases utilized functions for people and is then allowable for patent. It is also to be understood that the application, such as shown in FIG. 4 on an umbrella, is only exemplary, which can be applied on any suitable products. Any modification with the same or similar merit is still claimed in this application.

I claim:

1. A soft handle with a lighting apparatus including a central rod and a soft shell with inner liquid, both of which are made of transparent material, a lighting apparatus in lower portion of the central rod including several LED bulbs and a bottom switch and a soft cover connected at bottom of the central rod outside the switch.

2. The soft handle with a lighting apparatus as claimed in claim 1, wherein the lighting apparatus includes various circuits to control the LED bulbs lighting in different frequencies and rules.
